(19) United States
(12) Patent Application Publication
(10) Pub. No.: US 2007/0136458 A1
(43) Pub. Date: Jun. 14, 2007

(54) Creation and management of ATPT in switches of multi-host PCI topologies

(76) Inventors: William T. Boyd, Poughkeepsie, NY (US); Douglas M. Freimuth, New York, NY (US); William G. Holland, Cary, NC (US); Steven W. Hunter, Raleigh, NC (US); Renato J. Recio, Austin, TX (US); Steven M. Thurber, Austin, TX (US); Madeline Vega, Austin, TX (US)

Correspondence Address: IBM CORP (YA);C/O YEE & ASSOCIATES PC, P.O. BOX 802333, DALLAS, TX, 75380, US

(21) Appl. No.: 11/301,109

(22) Filed: Dec. 12, 2005

(51) Int. Cl. G06F 15/173

(52) U.S. Cl. 709/224

(57) ABSTRACT

A PCI control manager provides address translation protection tables in switches in a PCI fabric. The PCI control manager discovers the fabric and provides a virtual tree for each root complex. A system administrator may then remove endpoints that do not communicate with the root complex to configure the PCI fabric. The PCI control manager then provides updated ATPT tables to the switches. When a host or adapter is added, the master PCM goes through the discovery process and the ATPT tables and adapter routing tables are modified to reflect the change in configuration. The master PCM can query the ATPT tables and adapter routing tables to determine what is in the configuration. The master PCM can also destroy entries in the ATPT tables and adapter routing tables when a device is removed from the configuration and those entries are no longer valid.

### BACKGROUND OF THE INVENTION

1. Field of the Invention

The present invention relates generally to the data processing field, and more particularly, to communication between a host computer and an input/output (I/O) adapter through an I/O fabric. Still more particularly, the present invention pertains to creation and management of address translation protection tables in switches of multi-host PCI topologies.

2. Description of the Related Art

PCI (Peripheral Component Interconnect) Express is widely used in computer systems to interconnect host units to adapters or other components, by means of a PCI switched-fabric bus or the like. However, currently, PCI Express (PCIe) does not permit sharing of PCI adapters in topologies where there are Multiple Hosts with Multiple Shared PCI busses. Support for this type of function can be very valuable on blade clusters and on other clustered servers. Currently, PCI Express and secondary network (e.g. Fibre Channel, Infiniband, Ethernetnet) adapters are integrated into blades and server systems, and cannot be shared between clustered blades or even between multiple roots within a clustered system.

For blade environments, it can be very costly to dedicate these network adapters to each blade. For example, the current cost of a 10 Gigabit Ethernet adapter is in the $6000 range. The inability to share these expensive adapters between blades has contributed to the slow adoption rate of some new network technologies (e.g. 10 Gigabit Ethernet). In addition, there is a constraint in space available in blades for PCI adapters. A PCI network that is able to support attachment of multiple hosts and to share Virtual PCI I/O adapters among the multiple hosts would overcome these deficiencies in current systems.

In order to allow virtualization of PCI secondary adapters in this environment, a mechanism is needed to route MMIO (Memory-Mapped Input/Output) packets from a host to a target adapter, and to route DMA (Direct Memory Access) packets from an adapter to the appropriate host in such a way that the System Image's memory and data is prevented from being accessed by unauthorized applications in other System Images, and from other adapters in the same PCI tree. It is also desirable that such a mechanism be implemented with minimum changes to current PCI hardware.

Modifications are frequently made to a distributed computing system that affects the routing of data through the system. For example, I/O adapters in the system may be transferred from one host to another, or hosts and/or I/O adapters may be added to or removed from the system. In order to ensure that the routing mechanism described in the above-identified patent application functions as intended in such an environment, a mechanism is needed to manage the routing of data by the routing mechanism to reflect such modifications to the system.

### SUMMARY OF THE INVENTION

The present invention recognizes the disadvantages of the prior art and provides a mechanism for routing of data in a distributed computing system. The mechanism discovers a communications fabric, wherein the communications fabric includes at least one switch. The mechanism generates a view of a physical configuration of the communications fabric. The mechanism generates an address translation protection table for a given switch in the communications fabric, wherein each entry in the address translation protection table associates a routing number with an adapter routing table or an upstream port. The address translation protection table in stored association with the given switch.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram that illustrates a distributed computing system according to an exemplary embodiment of the present invention;

FIG. 2 is a block diagram that illustrates an exemplary logical partitioned platform in which exemplary aspects of the present invention may be implemented;

FIG. 3 is a diagram that illustrates a multi-root computing system interconnected through multiple bridges or switches according to an exemplary embodiment of the present invention;

FIG. 4 illustrates an example of packet routing to a root complex using an address translation protection table in accordance with exemplary aspects of the present invention;

FIG. 5 illustrates an example of packet routing to an adapter using a PCI address routing table in accordance with exemplary aspects of the present invention;

FIG. 6 illustrates a PCI configuration header according to an exemplary embodiment of the present invention;

FIG. 7 is a flowchart that illustrates management of routing of data in a distributed computing system according to exemplary aspects of the present invention;

FIG. 8 is a flowchart that illustrates assignment of addresses used in the routing of data in a distributed computing system according to an exemplary embodiment of the present invention;

FIG. 9 depicts a plurality of switch tables which are constructed by the PCI configuration manager as it acquires configuration information in accordance with exemplary aspects of the present invention; and

FIGS. 10A-10D depict an example configuration illustrating management of routing of data in a distributed computing system according to exemplary aspects of the present invention.

### DETAILED DESCRIPTION OF THE PREFERRED EMBODIMENT

The present invention applies to any general or special purpose computing system where multiple root complexes (RCs) are sharing a pool of I/O adapters through a common I/O fabric. More specifically, the exemplary embodiment described herein details the mechanism when the I/O fabric uses the PCI Express (PCIe) protocol.

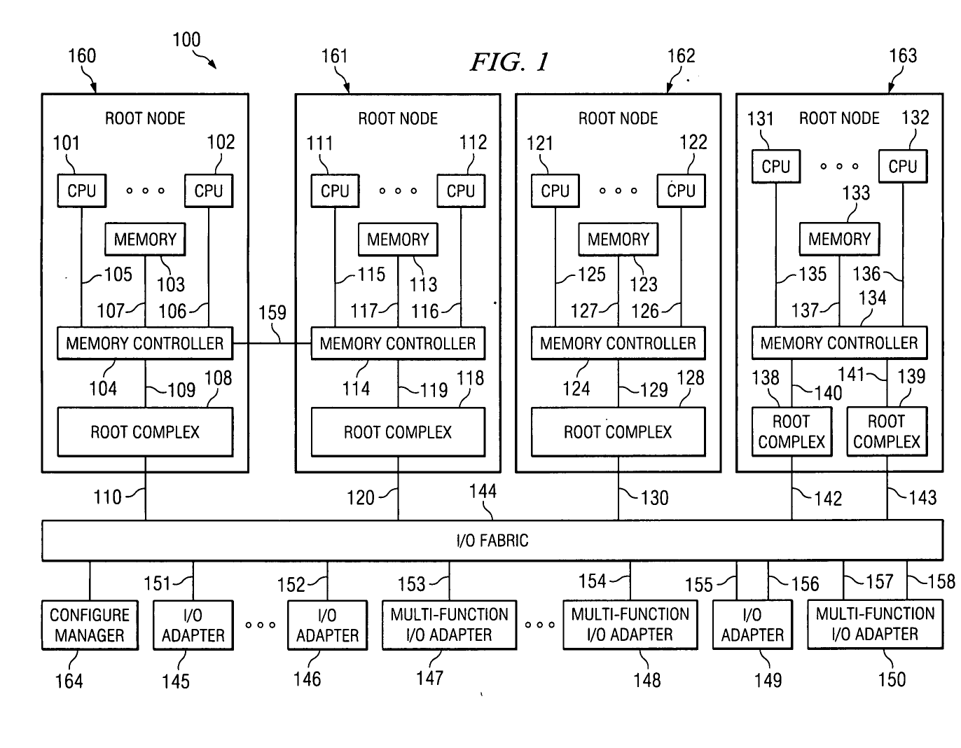

With reference now to the figures and in particular with reference to FIG. 1, a block diagram of a distributed computing system is depicted according to an exemplary embodiment of the present invention. The distributed computing system is generally designated by reference number 100 and takes the form of two or more Root Complexes (RCs), five RCs 108, 118, 128, 138, and 139 being provided in the exemplary embodiment illustrated in FIG. 1. RCs 108, 118, 128, 138, and 139 are attached to an I/O fabric 144 through I/O links 110, 120, 130, 142, and 143, respectively; and are connected to memory controllers 104, 114, 124, and 134 of root nodes (RNs) 160, 161, 162, and 163, through links 109, 119, 129, 140, and 141, respectively. I/O fabric 144 is attached to I/O adapters 145, 146, 147, 148, 149, and 150 through links 151, 152, 153, 154, 155, 156, 157, and 158. The I/O adapters may be single function I/O adapters, such as I/O adapters 145, 146, and 149; or multiple function I/O adapters, such as I/O adapters 147, 148, and 150. Further, the I/O adapters may be connected to I/O fabric 144 via single links as in I/O adapters 145, 146, 147, and 148; or with multiple links for redundancy as in 149 and 150.

RCs 108, 118, 128, 138, and 139 are each part of one of Root Nodes (RNs) 160, 161, 162, and 163. There may be one RC per RN as in the case of RNs 160, 161, and 162, or more than one RC per RN as in the case of RN 163. In addition to the RCs, each RN includes one or more Central Processing Units (CPUs) 101-102, 111-112, 121-122, and 131-132; memory 103, 113, 123, and 133; and memory controller 104, 114, 124, and 134, which connects the CPUS, memory, and I/O RCs, and performs such functions as handling the coherency traffic for the memory.

RNs may be connected together at their memory controllers, as illustrated by connection 159 connecting RNs 160 and 161, to form one coherency domain which may act as a single Symmetric Multi-Processing (SMP) system, or may be independent nodes with separate coherency domains as in RNs 162 and 163.

Configuration manager 164 may be attached separately to I/O fabric 144 as shown in FIG. 1, or may be part of one of RNs 160-163. Configuration manager 164 configures the shared resources of the I/O fabric and assigns resources to the RNs.

Distributed computing system 100 may be implemented using various commercially available computer systems. For example, distributed computing system 100 may be implemented using an IBM eServer® iSeries™ Model 840 system available from International Business Machines Corporation, Armonk, N.Y. Such a system may support logical partitioning using an OS/400® operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

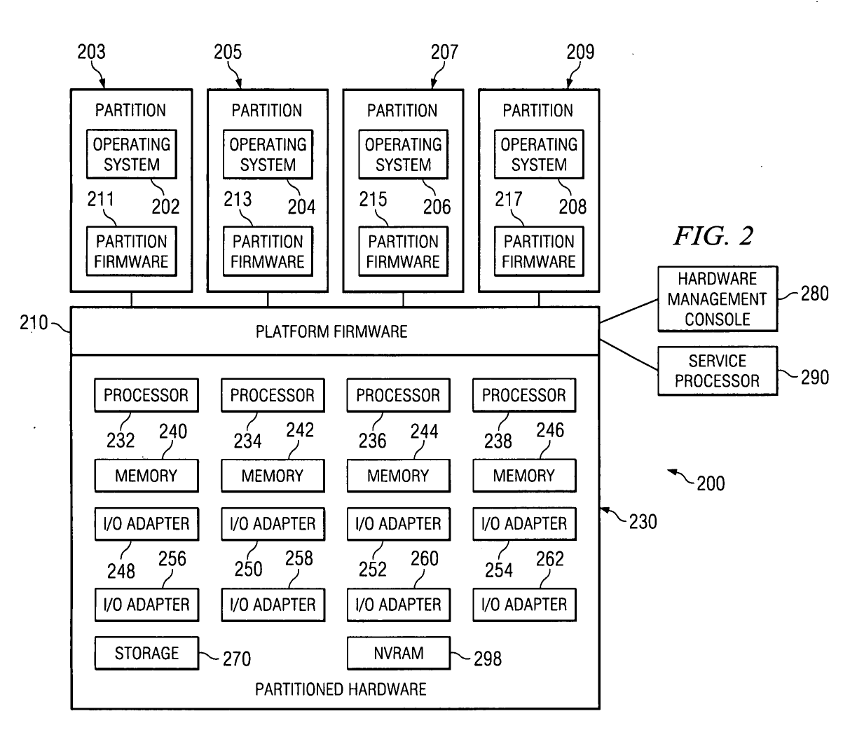

With reference now to FIG. 2, a block diagram of an exemplary logical partitioned platform is depicted in which exemplary aspects of the present invention may be implemented. The platform is generally designated by reference number 200, and hardware in logical partitioned platform 200 may be implemented as, for example, distributed computing system 100 in FIG. 1.

Logical partitioned platform 200 includes partitioned hardware 230; operating systems 202, 204, 206, and 208; and partition management firmware (platform firmware) 210. Operating systems 202, 204, 206 and 208 are located in partitions 203, 205, 207, and 209, respectively; and may be multiple copies of a single operating system or multiple heterogeneous operating systems simultaneously run on logical partitioned platform 200. These operating systems may be implemented using OS/400®, which is designed to interface with partition management firmware 210. OS/400® is intended only as one example of an implementing operating system, and it should be understood that other types of operating systems, such as AIX® and Linux™, may also be used, depending on the particular implementation.

An example of partition management software that may be used to implement partition management firmware 210 is Hypervisor software available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Partitions 203, 205, 207, and 209 also include partition firmware 211, 213, 215, and 217, respectively. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes a plurality of processors 232, 234, 236, and 238; a plurality of system memory units 240, 242, 244, and 246; a plurality of I/O adapters 248, 250, 252, 254, 256, 258, 260, and 262; storage unit 270 and Non-Volatile Random Access Memory (NVRAM) storage unit 298. Each of the processors 232-238, memory units 240-246, storage 270, NVRAM storage 298, and I/O adapters 248-262, or parts thereof, may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing the hardware resources of logical partitioned platform 200.

Service processor 290 may be used to provide various services, such as processing platform errors in the partitions. These services may also include acting as a service agent to report errors back to a vendor, such as International Business Machines Corporation.

Operations of the different partitions may be controlled through hardware management console 280. Hardware management console 280 is a separate distributed computing system from which a system administrator may perform various functions including allocation and/or reallocation of resources to different partitions.

Hardware management console 280 may also be used for managing routing of data in accordance with exemplary aspects of the present invention. Hardware management console 280 may provide a mechanism for discovering a communications fabric. Hardware management console 280 then generates a view of a physical configuration of the communications fabric. Hardware management console 280 presents a virtual tree for at least a first root complex to a user and receives input indicating deletion of endpoints form the virtual tree. Then, Hardware management console 280 generates an address translation protection table for a given switch in the communications fabric, wherein each entry in the address translation protection table associates a routing number with an adapter routing table or an upstream port. Thereafter, hardware management console 280 stores the address translation protection table in association with a switch in the communications fabric.

In a logical partitioned (LPAR) environment, it is not permissible for resources or programs in one partition to affect operations in another partition. Furthermore, to be useful, the assignment of resources needs to be fine-grained. For example, it is often not acceptable to assign all I/O adapters under a particular PCI Host Bridge (PHB) to the same partition, as that will restrict configurability of the system, including the ability to dynamically move resources between partitions.

Accordingly, some functionality is needed in the bridges and switches that connect I/O adapters to the I/O bus so as to be able to assign resources, such as individual I/O adapters or parts of I/O adapters to separate partitions and, at the same time, prevent the assigned resources from affecting other partitions such as by obtaining access to resources of the other partitions.

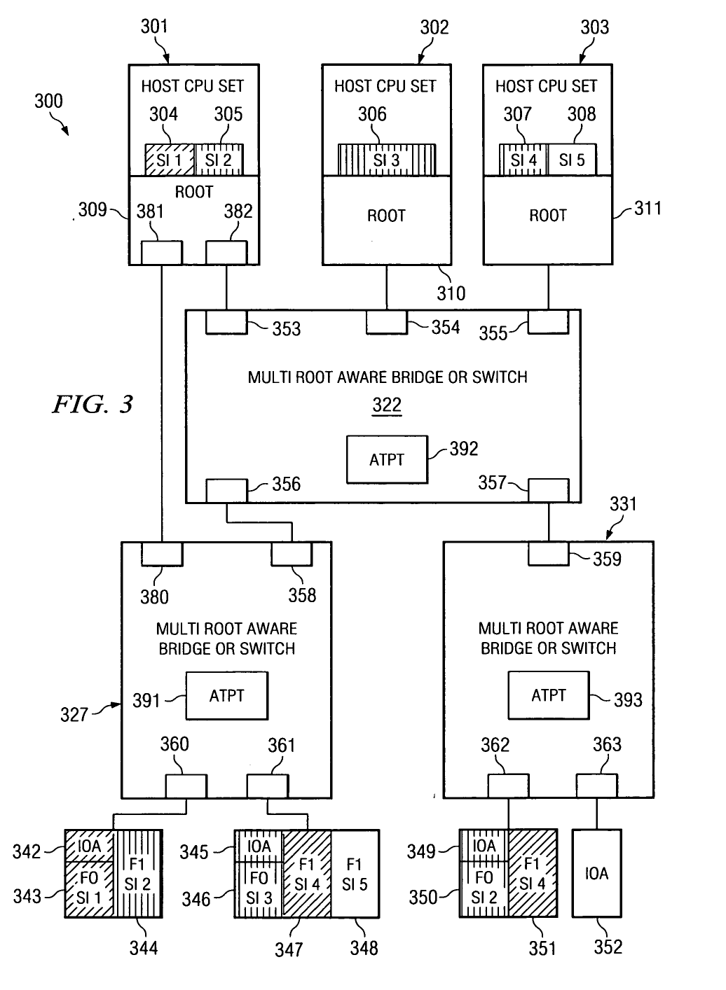

With reference now to FIG. 3, a diagram that illustrates a multi-root computing system interconnected through multiple bridges or switches is depicted according to an exemplary embodiment of the present invention. The system is generally designated by reference number 300. The mechanism presented in this description includes an address translating protection table (ATPT). This address translating protection table can be used in the routing mechanism to enable a PCI network to support the attachment of multiple hosts and share virtual PCI I/O adapters between those hosts.

Furthermore, FIG. 3 illustrates the concept of a PCI fabric that supports multiple roots through the use of multiple bridges or switches. The configuration consists of a plurality of host CPU sets 301, 302 and 303, each containing a single or a plurality of system images (SIs). In the configuration illustrated in FIG. 3, host CPU set 301 contains two SIs 304 and 305, host CPU set 302 contains SI 306 and host CPU 303 contains SIs 307 and 308. These systems interface to the I/O fabric through their respective RCs 309, 310, and 311. Each RC can have one port, such as RC 310 or 311, or a plurality of ports, such as RC 309, which has two ports 381 and 382. Host CPU sets 301, 302, and 303 along with their corresponding RCs will be referred to hereinafter as root nodes 301, 302, and 303.

Each root node is connected to a root port of a multi root aware bridge or switch, such as multi root aware bridges or switches 322 and 327. It is to be understood that the term “switch,” when used herein by itself, may include both switches and bridges. The term “bridge” as used herein generally pertains to a device for connecting two segments of a network that use the same protocol. In other words, a switch may be a bridge, which connects two network segments together. As shown in FIG. 3, root nodes 301, 302, and 303 are connected to root ports 353, 354, and 355, respectively, of multi root aware bridge or switch 322; and root node 301 is further connected to multi root aware bridge or switch 327 at root port 380. A multi root aware bridge or switch, by way of this invention, provides the configuration mechanisms necessary to discover and configure a multi root PCI fabric.

The ports of a bridge or switch, such as multi root aware bridge or switch 322, 327, or 331, can be used as upstream ports, downstream ports, or both upstream and downstream ports, where the definition of upstream and downstream is as described in PCI Express Specifications. In FIG. 3, ports 353, 354, 355, 359, and 380 are upstream ports, and ports 357, 360, 361, 362, and 363 are downstream ports. However, when using the ATPT based routing mechanism described herein, the direction is not necessarily relevant, as the hardware does not care which direction the transaction is heading since it routes the transaction using the unique address associated with each destination.

The ports configured as downstream ports are used to attach to adapters or to the upstream port of another bridge or switch. In FIG. 3, multi root aware bridge or switch 327 uses downstream port 360 to attach I/O adapter 342, which has two virtual I/O adapters or virtual I/O resources 343 and 344. Similarly, multi root aware bridge or switch 327 uses downstream port 361 to attach I/O adapter 345, which has three virtual I/O adapters or virtual I/O resources 346, 347, and 348. Multi root aware bridge or switch 322 uses downstream port 357 to attach to port 359 of multi root aware bridge or switch 331. Multi root aware bridge or switch 331 uses downstream ports 362 and 363 to attach I/O adapter 349 and I/O adapter 352, respectively.

The ports configured as upstream ports are used to attach a RC. In FIG. 3, multi root aware switch 327 uses upstream port 380 to attach to port 381 of root 309. Similarly, multi root aware switch 322 uses upstream ports 353, 354, and 355 to attach to port 382 of root 309, root 310's single port and root 311's single port.

In the exemplary embodiment illustrated in FIG. 3, I/O adapter 342 is a virtualized I/O adapter with its function 0 (F0) 343 assigned and accessible to SI1 304, and its function 1 (F1) 344 assigned and accessible to SI2 305. In a similar manner, I/O adapter 345 is a virtualized I/O adapter with its function 0 (F0) 346 assigned and accessible to SI3 306, its function 1 (F1) 347 assigned and accessible to SI4 307, and its function 3 (F3) assigned to SI5 308. I/O adapter 349 is a virtualized I/O adapter with its F0 350 assigned and accessible to SI2 305, and its F1 351 assigned and accessible to SI4 307. I/O adapter 352 is a single function I/O adapter assigned and accessible to SI5 308.

FIG. 3 also illustrates where the mechanisms for ATPT based routing would reside according to an exemplary embodiment of the present invention; however, it should be understood that other components within the configuration could also store whole or parts of address translation protection tables without departing from the spirit and scope of the invention. In FIG. 3, address translation protection tables 391, 392, and 393 are shown to be located in bridges or switches 327, 322, and 331, respectively.

In accordance with exemplary aspects of the present invention, a master node reads switch configuration space to determine if a switch supports ATPT based routing. If a switch supports the ATPT mechanism, the master creates ATPT entries for the hosts and adapters that are connected to the switch. When a host or adapter is added to the switch, the master modifies the ATPT to reflect the new configuration. The master may query the ATPT to determine what is in the configuration. The master may also destroy entries in the ATPT when those entries are no longer valid.

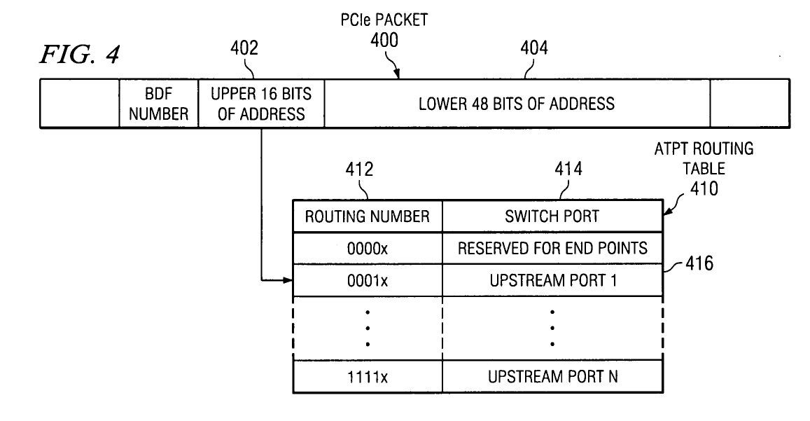

FIG. 4 illustrates an example of packet routing to a root complex using an address translation protection table in accordance with exemplary aspects of the present invention. PCIe packet 400 includes a BDF# and an address. The upper 16 bits 402 of the address are mapped to ATPT routing table 410. The address also includes lower 48 bits 404.

Each entry of ATPT routing table 410 includes a routing number 412 and an upstream switch port 414. Note that no upstream port is mapped to 0000x, because that address is reserved for use by routing to the adapters via downstream ports. In the depicted example, upper 16 bits 402 of the address point to entry 416 in ATPT routing table 410. Therefore, a PCIe packet 400 with upper 16 bit address of 0001x is routed to upstream port 1.

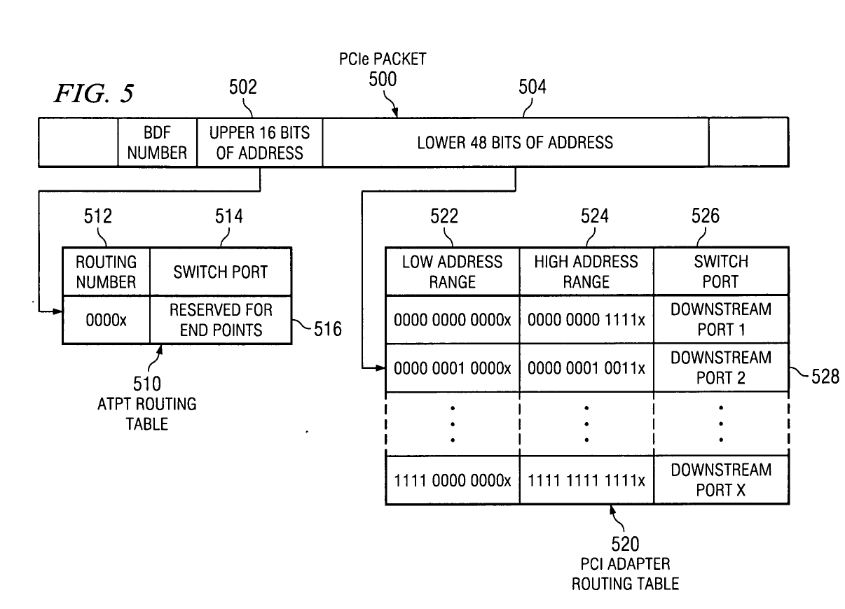

FIG. 5 illustrates an example of packet routing to an adapter using a PCI address routing table in accordance with exemplary aspects of the present invention. PCIe packet 500 includes a BDF# and an address. The upper 16 bits 502 of the address are mapped to ATPT routing table 510. Each entry in ATPT routing table 510 includes a routing number 512 and a switch port 514.

In the depicted example, upper 16 bits 502 of the address point to entry 516 in ATPT routing table 510. Entry 516 indicates that the packet is to be routed to an endpoint, i.e. an I/O adapter. Lower 48 bits 504 of the address point to PCI adapter routing table 520. Each entry in PCI adapter routing table 520 includes a low address 522 of an address range, a high address 524 of an address range, and a switch port 526. In this instance, lower 48 bits 504 of the address point to entry 528. Therefore, a PCIe packet 500 with address 0000 0000 0001 0010x is routed to downstream port 2.

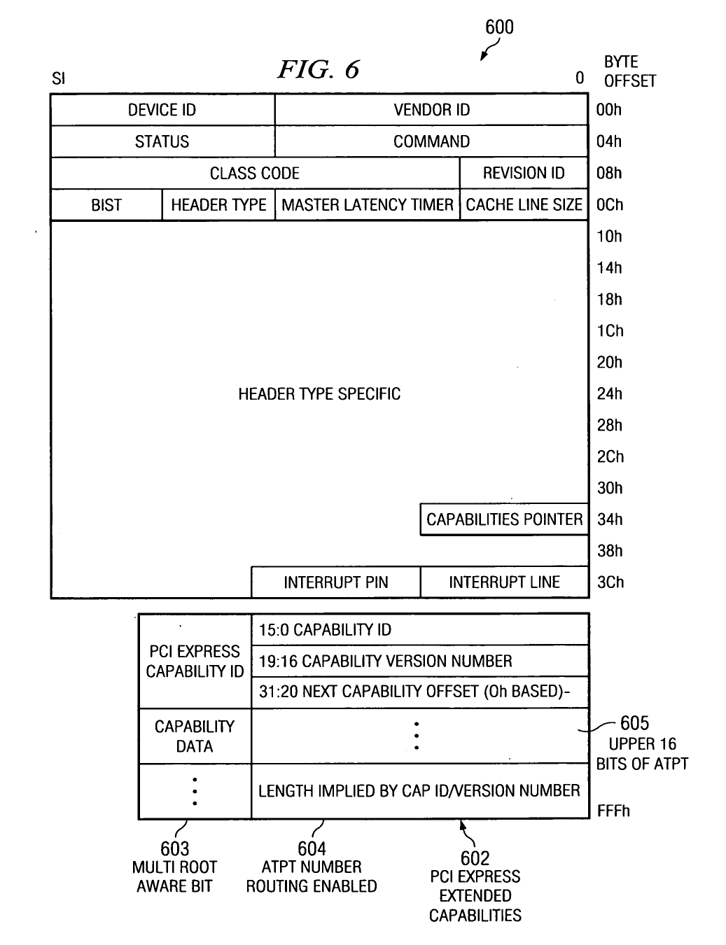

FIG. 6 illustrates a PCI configuration header according to an exemplary embodiment of the present invention. The PCI configuration header is generally designated by reference number 600, and PCIe starts its extended capabilities 602 at a fixed address in PCI configuration header 600. These can be used to determine if the PCI component is a multi-root aware PCI component and if the device supports ATPT-based routing. If the PCIe extended capabilities 602 have multi-root aware bit 603 set and ATPT based routing supported bit 604 set, then the ATPT information for the device can be stored in an address pointed to by field 605 in the PCIe extended capabilities area. It should be understood, however, that the present invention is not limited to the herein described scenario where the PCI extended capabilities are used to define the ATPT. Any other field could be redefined or reserved fields could be used for the ATPT implementation on other specifications for PCI.

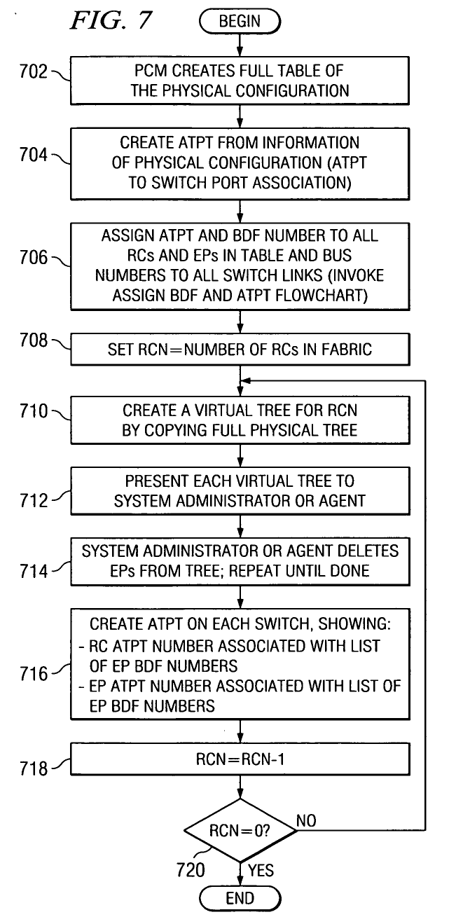

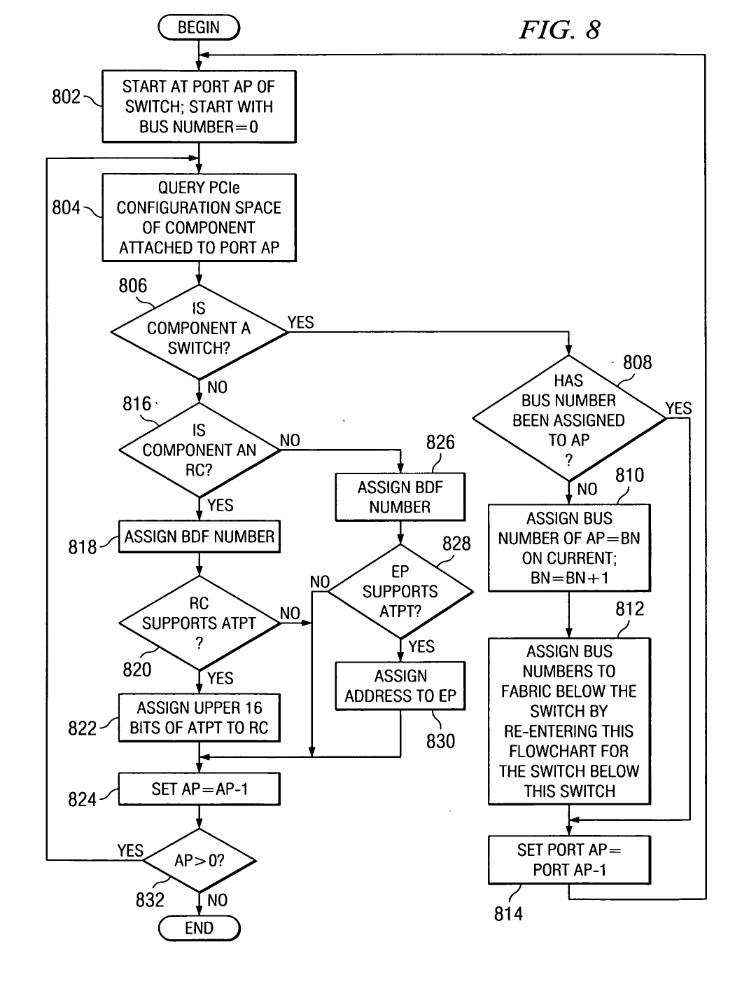

FIG. 7 is a flowchart that illustrates management of routing of data in a distributed computing system according to exemplary aspects of the present invention. Operation begins by a PCI control manager (PCM) creating a full table of the physical configuration of the I/O fabric (block 702). The PCM then creates an ATPT from the information on physical configuration to make “ATPT-to-switch port” associations (block 704). The PCM then assigns the ATPT and BDF# to all RCs and EPs in the table and Bus numbers are assigned to all switch to switch links (block 706) (this invokes the flowchart shown in FIG. 8, which is described in further detail below).

After an ATPT and BDF number have been assigned to all RCs and EPs in the table, and Bus numbers are assigned to all switch-to-switch links in block 706, the RCN is set to the number of RCs in the fabric (block 708), and a virtual tree is created for the RCN by copying the full physical tree (block 710). The virtual tree is then presented to the administrator or agent for the RC (block 712). The system administrator or agent deletes EPs from the tree (block 714), and a similar process is repeated until the virtual tree has been fully modified as desired.

An ATPT Validation Table (ATPTVT) is then created on each switch showing the RC ATPT number associated with the list of EP BDF numbers, and the EP ATPT number associated with the list of EP BDF numbers (block 716). The RCN is then set equal to RCN−1 (block 718). Thereafter, a determination is made as to whether RCN=0 (block 720). If the RCN=0, then operation ends. If RCN does not equal 0 in block 720, then operation returns to block 710 to create a virtual tree by copying the next physical tree and repeating the subsequent steps for the next virtual tree.

FIG. 8 is a flowchart that illustrates assignment of addresses used in the routing of data in a distributed computing system according to an exemplary embodiment of the present invention. Operation begins and the PCM starts at the active port (AP) of the switch, and starts with Bus#=0 (block 802). The PCM then queries the PCIe Configuration Space of the component attached to the AP (block 804).

A determination is then made as to whether the component is a switch (block 806). If the component is a switch, a determination is made whether a bus number has been assigned to port AP (block 808). If a Bus# has been assigned to port AP, port AP is set equal to port AP−1 (block 814), and operation returns to block 802 to repeat the operation with the next port.

If a bus number has not been assigned to port AP in block 808), a bus number (bus# or BN) of AP=BN is assigned on the current port; BN=BN+1 (block 810), and bus numbers are assigned to the I/O fabric below the switch by re-entering this flowchart for the switch below the current switch (block 812). Port AP is then set equal to port AP−1 (block 814), and operation returns to block 802 to repeat operation with the next port.

Returning to block 806, if the component is determined not to be a switch, a determination is made as to whether the component is an RC (block 816). If the component is an RC, a BDF number is assigned (block 818) and a determination is made as to whether the RC supports ATPT (block 820). If the RC does support ATPT in block 820, the upper 16 bits of the ATPT is assigned to the RC (block 822). The AP is then set to be equal to AP−1 (block 824). If the RC does not support ATPT in block 820), the AP is set=AP−1 (block 824).

If the component is determined not to be an RC in block 816, a BDF number is assigned (block 826) and a determination is made whether the EP supports ATPT (block 828). If the EP supports ATPT, the ATPT is assigned to EP (block 830). Then, the AP is set=AP−1 (block 824). If the EP does not support ATPT in block 828, the AP is set=AP−1 (block 928).

After AP is set to AP−1 in block 828, a determination is made as to whether AP is greater than zero (block 832). If the AP is not greater than zero, then operation ends. If the AP is greater than zero in block 832, then operation returns to block 804 to query the PCIe configuration space of the component attached to the next port.

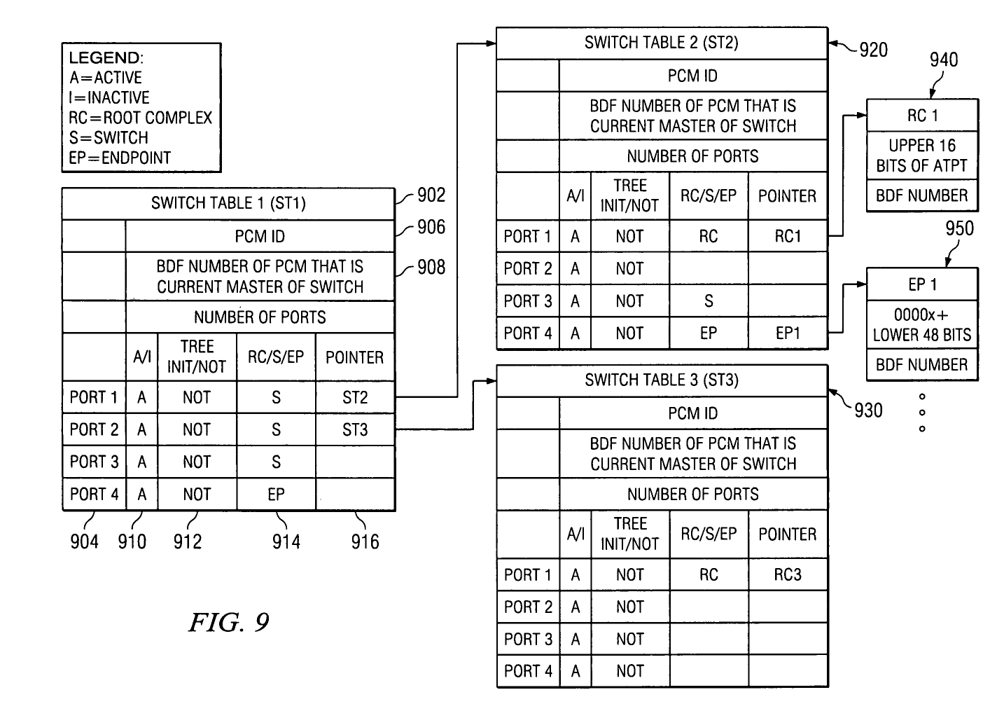

With reference now to FIG. 9, there is shown a plurality of switch tables which are constructed by the PCI configuration manager as it acquires configuration information in accordance with exemplary aspects of the present invention. The configuration information is usefully acquired by querying portions of the PCIe configuration space respectively attached to a succession of active ports (AP). More particularly, switch table 1 (ST1) 902 including an information space 904 that shows the state of a particular switch in distributed system 300. Information space 904 includes a field 906, containing the identity of the current PCM, and a field 908 that indicates the total number of ports the switch has. For each port, field 910 indicates whether the port is active or inactive, and field 912 indicates whether a tree associated with the port has been initialized. Field 914 shows whether the port is connected to a root complex (RC), to a bridge or switch (S) or to an endpoint (EP).

If the port is connected to a switch, then pointer field 916 points to an ATPT table for a switch. Similarly, if the port is connected to a root complex (RC), then pointer field 916 points to an RC table, and if the port is connected to an endpoint, then filed 916 points to an EP table. In this example, port 1 is connected to a switch and field 916 for the port 1 entry points to switch table 2 (ST2) 920. Also, as illustrated in the example of FIG. 9, port 2 is connected to a switch and field 916 for the port 2 entry points to switch table 3 (ST3) 930.

In the example of ST1 920, port 1 is connected to a root complex and the pointer field for port 1 points to RC table 940. Also, in the example of ST1 920, as shown in FIG. 9, port 4 is connected to an endpoint. Therefore, the pointer field for port 4 points to EP table 950.

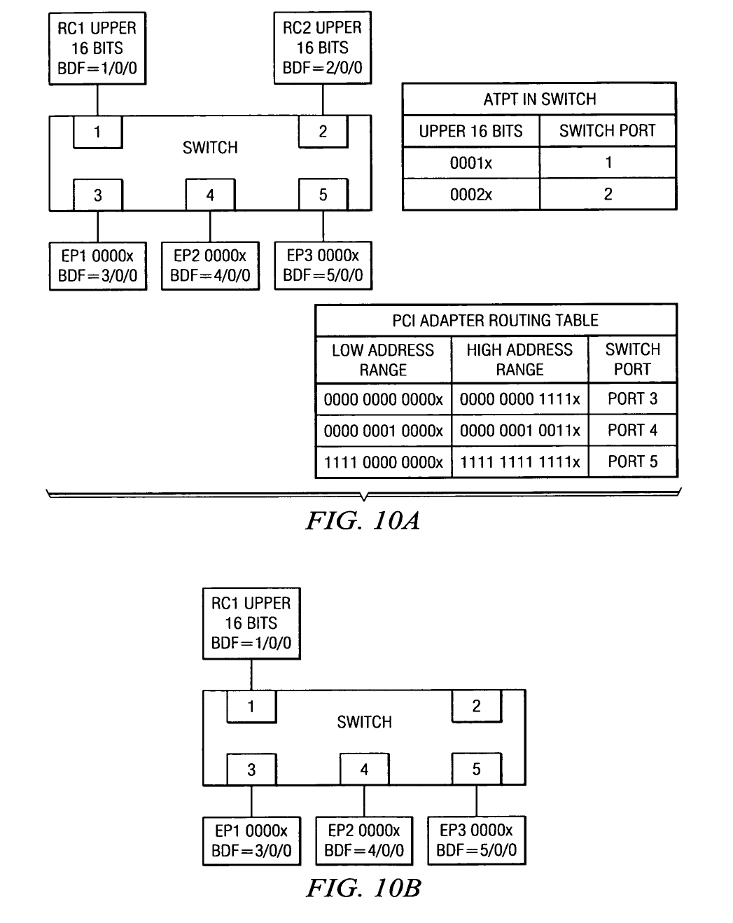

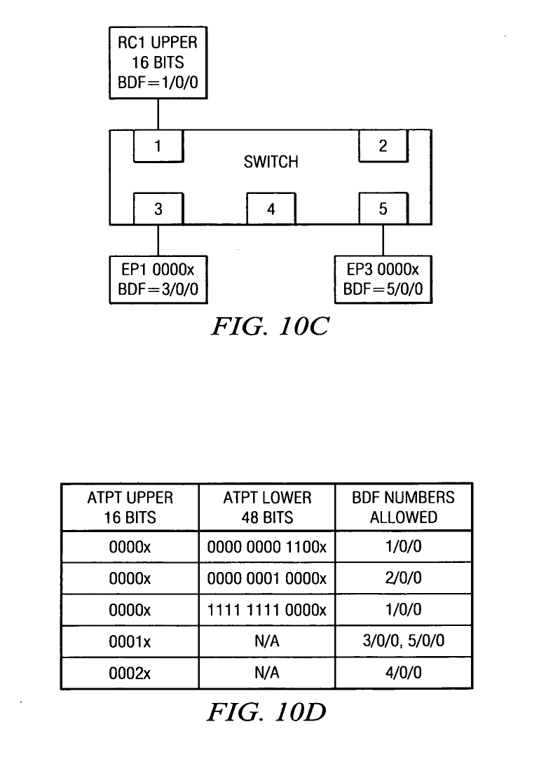

FIGS. 10A-10D depict an example configuration illustrating management of routing of data in a distributed computing system according to exemplary aspects of the present invention. After the PCM discovers the fabric, it generates a view of the physical configuration as shown in FIG. 10A. The PCM creates a full table, including the ATPT in the switch and the PCI address routing table. FIG. 10B illustrates the virtual tree that will be presented to the system administrator or agent for root cluster 1 (RC1). As discussed above with reference to FIG. 7, the administrator deletes the endpoints that will not communicate with RC1. The result is as shown in FIG. 10C, for example.

The PCM then repeats the steps of generating a virtual tree and allowing the system administrator to delete endpoints for RC2, in this example. When the process is finished, the ATPT VT in port is as shown in FIG. 10D. FIG. 10D illustrates an ATPT validation table, which describes which endpoints can talk to which root complexes and vice versa.

Thus, the present invention solves the disadvantages of the prior art by providing a PCI control manager that provides address translation protection tables in switches in a PCI fabric. The PCI control manager discovers the fabric and provides a virtual tree for each root complex. A system administrator may then remove endpoints that do not communicate with the root complex to configure the PCI fabric. The PCI control manager then provides updated ATPT tables to the switches.

When a host or adapter is added, the master PCM goes through the discovery process and the ATPT tables and adapter routing tables are modified to reflect the change in configuration. The master PCM can query the ATPT tables and adapter routing tables to determine what is in the configuration. The master PCM can also destroy entries in the ATPT tables and adapter routing tables when a device is removed from the configuration and those entries are no longer valid.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen And described in order to best explain the principles of the invention, the practical application, and to enable others of ordinary skill in the art to understand the invention for various embodiments with various modifications as are suited to the particular use contemplated.

What is claimed is:

1. A computer implemented method for routing of data in a distributed computing system, the computer implemented method comprising:
discovering a communications fabric, wherein the communications fabric includes at least one switch;
generating a view of a physical configuration of the communications fabric;
generating an address translation protection table for a given switch in the communications fabric, wherein each entry in the address translation protection table associates a routing number with an adapter routing table or an upstream port; and
storing the address translation protection table in association with the given switch.

2. The computer implemented method of claim 1, further comprising:
receiving a packet, wherein the packet identifies an address;
identifying an entry in the address translation protection table associated with a first portion of the address;
determining whether the entry in the address translation protection table is associated with an upstream port or a downstream port; and
if the entry in the address translation protection table is associated with an upstream port, routing the packet to the upstream port.

3. The computer implemented method of claim 2, further comprising:
if the entry in the address translation protection table is associated with a downstream port, identifying an entry in an adapter routing table associated with a second portion of the address;
identifying a downstream port from the entry in the adapter routing table; and
routing the packet to the downstream port.

4. The computer implemented method of claim 2, wherein the upstream port is connected to a second switch.

5. The computer implemented method of claim 1, wherein generating an address translation protection table for a given switch in the communications fabric comprises:
creating a virtual tree for at least a first root complex;
presenting the virtual tree to a user;
receiving input indicating deletion of endpoints form the virtual tree.

6. The computer implemented method of claim 5, further comprising:
repeating the creating step, the presenting step, and the receiving step for each root complex in the communications fabric.

7. The computer implemented method of claim 1, wherein the at least one switch comprises a bridge connecting two network segments within the communications fabric.

8. The computer implemented method of claim 1, wherein the communications fabric uses peripheral component interconnect express protocol.

9. A managing system for managing routing of data in a distributed computing system, the managing system comprising:
a communications fabric, wherein the communications fabric includes at least one switch;
a hardware management console that discovers the communications fabric, generates a view of a physical configuration of the communications fabric, generates an address translation protection table for a given switch in the communications fabric, wherein each entry in the address translation protection table associates a routing number with an adapter routing table or an upstream port, and stores the address translation protection table in association with the given switch.

10. The managing system of claim 9, wherein the hardware management console receives a packet, wherein the packet identifies an address, identifies an entry in the address translation protection table associated with a first portion of the address, determines whether the entry in the address translation protection table is associated with an upstream port or a downstream port, and if the entry in the address translation protection table is associated with an upstream port, routes the packet to the upstream port.

11. The managing system of claim 10, wherein the hardware management console identifies an entry in an adapter routing table associated with a second portion of the address if the entry in the address translation protection table is associated with a downstream port, identifies a downstream port from the entry in the adapter routing table, and routes the packet to the downstream port.

12. The managing system of claim 9, wherein the hardware management console generates an address translation protection table for a given switch in the communications fabric by:
creating a virtual tree for at least a first root complex;
presenting the virtual tree to a user;
receiving input indicating deletion of endpoints form the virtual tree.

13. The managing system of claim 9, wherein the at least one switch comprises a bridge connecting two network segments within the communications fabric.

14. The managing system of claim 9, wherein the communications fabric uses peripheral component interconnect express protocol.

15. A computer program product for routing of data in a distributed computing system, the computer program product comprising:
a computer usable medium having computer usable program code embodied therein;
computer usable program code configured to discover a communications fabric, wherein the communications fabric includes at least one switch;
computer usable program code configured to generate a view of a physical configuration of the communications fabric;
computer usable program code configured to generate an address translation protection table for a given switch in the communications fabric, wherein each entry in the address translation protection table associates a routing number with an adapter routing table or an upstream port; and
computer usable program code configured to store the address translation protection table in association with the given switch.

16. The computer program product of claim 15, further comprising:
computer usable program code configured to receive a packet, wherein the packet identifies an address;
computer usable program code configured to identify an entry in the address translation protection table associated with a first portion of the address;
computer usable program code configured to determine whether the entry in the address translation protection table is associated with an upstream port or a downstream port; and
computer usable program code configured to route the packet to the upstream port if the entry in the address translation protection table is associated with an upstream port.

17. The computer program product of claim 16, further comprising:
computer usable program code configured to identify an entry in an adapter routing table associated with a second portion of the address if the entry in the address translation protection table is associated with a downstream port;
computer usable program code configured to identify a downstream port from the entry in the adapter routing table; and
computer usable program code configured to route the packet to the downstream port.

18. The computer program product of claim 15, wherein the computer usable program code configured to generate an address translation protection table for a given switch in the communications fabric comprises:
computer usable program code configured to create a virtual tree for at least a first root complex;
computer usable program code configured to present the virtual tree to a user;
computer usable program code configured to receive input indicating deletion of endpoints form the virtual tree.

19. The computer program product of claim 15, wherein the at least one switch comprises a bridge connecting two network segments within the communications fabric.

20. The computer program product of claim 15, wherein the communications fabric uses peripheral component interconnect express protocol.
